(19) United States
(12) Patent Application Publication
(10) Pub. No.: US 2024/0300299 A1
(43) Pub. Date: Sep. 12, 2024

(54) GEAR PUMP

(71) Applicant: Eberspächer Climate Control Systems GmbH, Esslingen (DE)

(72) Inventor: Marcel Scharla, Wendlingen/Neckar (DE)

(21) Appl. No.: 18/597,571

(22) Filed: Mar. 6, 2024

(30) Foreign Application Priority Data
Mar. 7, 2023 (DE) 10 2023 105 504.6

(51) Int. Cl. B60H 1/22; F04C 2/08; F23K 5/14

(52) U.S. Cl. CPC B60H 1/2203; F04C 2/084; F23K 5/145; F04C 2210/203; F04C 2240/30; F04C 2240/56; F04C 2240/60

(57) ABSTRACT

A gear pump is provided, for example, to convey liquid fuel in a fuel-operated heating apparatus. The gear pump includes a conveying chamber in a pump housing, a housing cover which closes the conveying chamber at least in regions, a conveying gear wheel which in the conveying chamber is rotatable about a rotation axis, a drive shaft which for co-rotation about the rotation axis is coupled to the conveying gear wheel, a first bearing unit for mounting the drive shaft on a first axial side of the conveying gear wheel, and a second bearing unit for mounting the drive shaft on a second axial side of the conveying gear wheel.

### CROSS-REFERENCE TO RELATED APPLICATIONS

This application claims priority of German patent application no. 10 2023 105 504.6, filed Mar. 7, 2023, the entire content of which is incorporated herein by reference.

### TECHNICAL FIELD

The present disclosure relates to a gear pump which can be used, for example, for conveying liquid fuel in a fuel-operated heating apparatus. Fuel-operated heating apparatuses of this type can be operated in a stationary manner, for example as building heaters, or can be used for example as auxiliary heaters or independent heaters in vehicles, for example for heating the air to be directed into a vehicle interior.

### BACKGROUND

Gear pumps of this type generally have two gear wheels which are disposed so as to mesh with one another in a conveying chamber. In order for the two gear wheels to be driven for rotation and in the process to convey liquid medium present in the conveying chamber, one of these gear wheels is supported on a drive shaft which is able to be driven for rotation by an electric-motor drive, for example. The drive shaft, which is disposed in a pump housing that also provides the conveying chamber, for example, is mounted so as to be rotatable relative to the pump housing in a region axially between the drive and the conveying gear wheel which is co-rotationally coupled to the drive shaft.

### SUMMARY

It is an object of the present disclosure to configure a gear pump of this type in such a way that excessive wear, in particular in the region of a conveying gear wheel supported on a drive shaft, is avoided when conveying non-lubricating media such as, for example, non-lubricating fuels.

According to the disclosure, this object is achieved by a gear pump, in particular for conveying liquid fuel in a fuel-operated heating apparatus, including:
a conveying chamber in a pump housing,
a housing cover which closes the conveying chamber at least in regions,
a conveying gear wheel which in the conveying chamber is rotatable about a rotation axis,
a drive shaft which for co-rotation about the rotation axis is coupled to the conveying gear wheel,
a first bearing unit for mounting the drive shaft on a first axial side of the conveying gear wheel;
a second bearing unit for mounting the drive shaft on a second axial side of the conveying gear wheel.

As a result of the drive shaft being mounted on both axial sides of the conveying gear wheel which for co-rotation is coupled to the drive shaft, transverse loads of the drive shaft, which are induced in particular by the comparatively high pressure of the conveyed liquid medium created during the conveying operation and may lead to the conveying gear wheel coming into contact with the walls of the pump housing that delimit the conveying chamber when moving transversely to the rotation axis, can be avoided. Excessive wear on the conveying gear wheel, in particular in the region of the teeth of the latter, can be avoided in this way.

The drive shaft via the first bearing unit can be mounted relative to the pump housing. Furthermore, the drive shaft via the second bearing unit can be mounted relative to the housing cover.

In order for a construction which is able to be implemented in an ideally simple and cost-effective manner to be obtained, the drive shaft can be self-supporting between the first bearing unit und the second bearing unit. As a result of the mounting at only two bearing points, which in axial terms are on both sides of the drive gear wheel, it is guaranteed that the drive shaft and thus also the conveying gear wheel are reliably supported in relation to lateral evasive movements.

For the avoidance of lateral evasive movements of this type in the region of the conveying gear wheel, it is particularly advantageous herein for an axial spacing of the second bearing unit from the conveying gear wheel to be smaller than an axial spacing of the first bearing unit from the conveying gear wheel.

In order to guarantee a long operational life span, it is proposed that the first bearing unit includes a first rolling-element bearing. For example, the first rolling-element bearing herein can include a ball bearing.

In order to shield this rolling-element bearing in relation to the liquid medium to be conveyed, it is proposed that the first bearing unit, axially between the first rolling-element bearing and the conveying gear wheel, includes a first shaft seal, for example a rotary shaft seal, providing a fluid-tight connection between the drive shaft and the pump housing.

The second bearing unit can include a second rolling-element bearing, for example a ball bearing.

In order to also shield this rolling-element bearing in relation to the liquid medium to be conveyed, it is proposed that the second bearing unit, axially between the second rolling-element bearing and the conveying gear wheel, includes a second shaft seal, for example a rotary shaft seal, providing a fluid-tight connection between the drive shaft and the housing cover.

In an alternative which is advantageous in particular in terms of the installation space required and the production costs, the second bearing unit can include a plain bearing bushing.

The plain bearing bushing can be constructed using polymer material or composite material, thus a material which is particularly suitable for use in a plain bearing bushing of this type in non-lubricating, or completely dry, environments.

The disclosure furthermore relates to a fuel-operated vehicle heating apparatus, including a burner region which is to be supplied with combustion air via a fan, and with liquid fuel via a gear pump constructed according to the disclosure. The burner region preferably has an atomizing burner in which a mixture of fuel and combustion air is generated by injecting fuel via an atomizing nozzle.

### BRIEF DESCRIPTION OF DRAWINGS

The invention will now be described with reference to the drawings wherein:

FIG. 1 shows a partial sectional view of a gear pump;

FIG. 2 shows a view, corresponding to that of FIG. 1, of an alternative type of configuration embodiment; and,

FIG. 3 shows a diagrammatic illustration of a fuel-operated vehicle heating apparatus.

### DETAILED DESCRIPTION

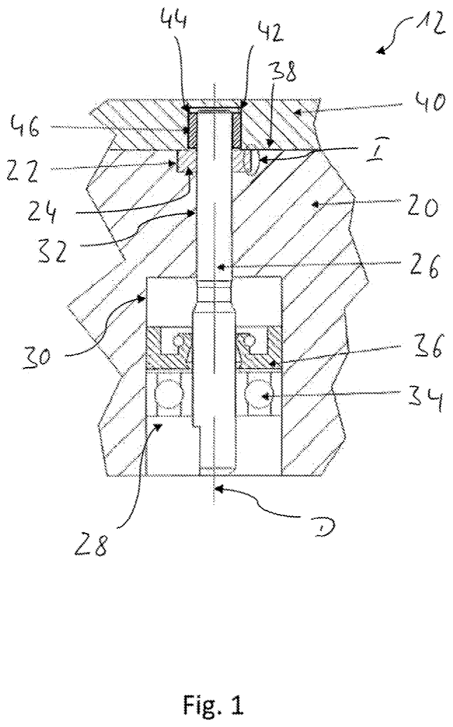

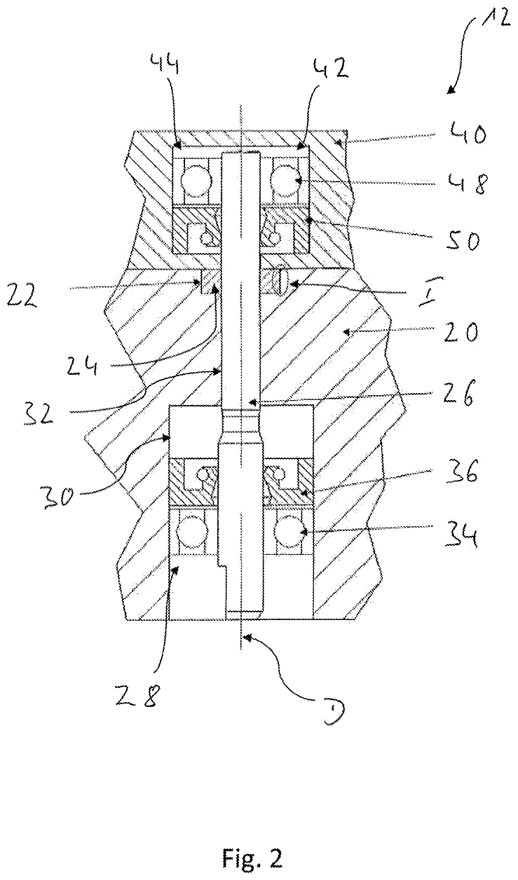

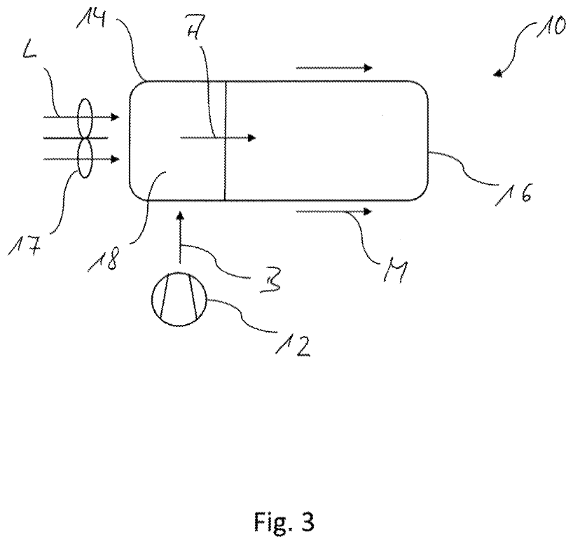

Before describing in detail the construction of a gear pump hereunder with reference to FIGS. 1 and 2, the fundamental construction of a fuel-operated vehicle heating apparatus, which is generally denoted by the reference numeral 10, will be explained with reference to FIG. 3, in which fuel-operated vehicle heating apparatus 10 a gear pump 12 of this type can be used for conveying liquid fuel as a liquid medium.

The vehicle heating apparatus 10 includes a burner region 14 and a heat exchanger region 16. The burner region 14 is supplied with combustion air L via a combustion air fan 17. Furthermore, the burner region 14 is supplied with liquid fuel B via the gear pump 12, which liquid fuel B is injected by an atomizing nozzle so as to generate a fuel/combustion air mixture. In a combustion chamber 18 of the burner region 14, the combustion air L is mixed with the fuel B, which has been evaporated by a porous evaporation medium, for example, so that a combustible mixture of combustion air L and fuel B is created. Before the combustion exhaust gases A created during combustion are discharged into the environment, they flow into the heat exchanger region 16 in which heat transported in the combustion exhaust gas A is transferred to a medium M to be heated. For example, this medium M to be heated can be the air to be directed into a vehicle interior. In principle however, the medium M may also be a liquid medium, for example the liquid cooling medium present in a coolant circuit of an internal combustion engine of a vehicle.

The gear pump 12 includes a pump housing, which is generally denoted by reference numeral 20. On one side of the pump housing, a conveying gear wheel 24 configured as a spur gear is disposed in a conveying chamber which is generally denoted by the reference numeral 22. The conveying gear wheel 24 is fixedly supported on a drive shaft 26 extending substantially in the pump housing 20 so that the drive shaft 26 and the conveying gear wheel 24 co-rotate about a rotation axis D when the drive shaft 26 is set in rotation by a drive not illustrated in FIG. 2, for example an electric motor.

Not to be seen in FIG. 1 is a further conveying gear wheel which, like the conveying gear wheel 24, is disposed in the conveying chamber 22 and lies laterally next to the conveying gear wheel 24 relative to the rotation axis D in such a manner that the further conveying gear wheel meshes with the conveying gear wheel 24. When the conveying gear wheel 24 rotates about the rotation axis D, this further conveying gear wheel, not to be seen in FIG. 1, is thus also driven for rotation, as a result of which a liquid medium present in the conveying chamber 22 and to be conveyed out of the conveying chamber 22 is displaced and thus discharged in the direction of a system region to be supplied, thus the combustion chamber 18, for example.

In a region of extent lying in the interior of the pump housing 20, the drive shaft 26 is mounted via a first bearing unit 28. The first bearing unit 28 is disposed in a radially extended region 30 of a shaft opening 32 of the pump housing 20 that receives the drive shaft 26. The first bearing unit 28 includes a first rolling-element bearing 34 which is configured as a ball bearing, for example, and mounts the drive shaft 26 radially so as to be rotatable relative to the pump housing 20. In order to shield this first rolling-element bearing 34 in relation to the medium to be conveyed, and in particular to also prevent leakage of the medium to be conveyed by way of the shaft opening 32, the first bearing unit 28, axially between the conveying gear wheel 24 and the first rolling-element bearing 34, includes a shaft seal 36 which is configured as a rotary shaft seal, for example. The latter bears on the external circumference of the drive shaft 26 as well as on the internal circumference of the radially extended region 30 of the shaft opening 32, thus implementing a fluid-tight connection between the drive shaft 26, which is rotatable about the rotation axis D, and the pump housing 20.

A housing cover 40 is disposed on an end side 38 of the pump housing 20, toward which the conveying chamber 22 is also open in principle, and fixedly connected to the pump housing 20 in such a manner that the conveying chamber 22 is closed in the direction of the rotation axis D by the housing cover 40.

The drive shaft 26 extends axially beyond the conveying gear wheel 24 into a clearance 42 formed in the housing cover 40. In this clearance 42, the drive shaft 26 is mounted so as to be rotatable relative to the housing cover 42 via a second bearing unit 44. In the configuration embodiment illustrated in FIG. 1, the second bearing unit 44 includes a plain bearing bushing 46. The plain bearing bushing 46 is constructed using a material which is particularly suitable for use in conjunction with non-lubricating, or dry-running, environments. For example, the plain bearing bushing 46 can be constructed or coated with polymer material at least in its surface region that radially supports the drive shaft 26. The use of composite materials is also possible, at least in the surface region that radially supports the drive shaft 26. Composite materials of this type can include, for example, a carrier body or a carrier layer in which solid lubricant particles are embedded. A carrier material of this type can be lead or copper, for example, and the solid lubricant particles embedded in this carrier material can be constructed from PTFE material. Plain bearing bushings of this type, which are particularly suitable for use in conjunction with a gear pump, are marketed under the brand or trade mark DU Bush/Bushing by GGB Heilbronn GmbH, for example. These are plain bearing bushings which are configured with a main body constructed from steel material. A porous sintered bronze intermediate layer is applied to this steel main body, and the porous sintered bronze intermediate layer on the side thereof provided for mounting is in turn covered by a running layer mixture of PTFE and lead.

By mounting the drive shaft 26 on both axial sides of the conveying gear wheel 24, and in particular also as a result of the second bearing unit 44 in axial terms being positioned significantly closer to the conveying gear wheel 24 than the first bearing unit 28, lateral evasive movements of the drive shaft 26, and thus of the conveying gear wheel 24, are substantially completely precluded in those axial regions in which the conveying gear wheel 24 is supported on the drive shaft 26. The risk that the conveying gear wheel 24 in the radially outer region thereof, which in FIG. 1 is bordered by a line I, by way of its teeth impacts on a wall of the pump housing 20 that delimits the conveying chamber 24, and excessive wear on the conveying gear wheel 24 is created as a result, can thus be precluded. As a result, the gear pump 12 is particularly suitable for use in conjunction with non-lubricating media or fuels such as, for example, kerosene, gasoline or the like. The addition of lubricating additives can therefore be dispensed with. As a result of the drive shaft 26 being mounted by the two bearing units 28, 44 on both axial sides of the conveying gear wheel 24, additional mounting measures, for example a further bearing unit between the first bearing unit 28 and the conveying gear wheel 24, and/or a further bearing unit between the first bearing unit 28 and the drive, not illustrated in the figures, can be dispensed with.

An alternative configuration embodiment of a gear pump 12 of this type, in particular for use in conjunction with non-lubricating media to be conveyed, is illustrated in FIG. 2. In the configuration embodiment illustrated in FIG. 2, the second bearing unit 44 is constructed using a second rolling-element bearing 48 by way of which the drive shaft 26 is radially supported on the housing cover 40. A second shaft seal 50, for example again in the form of a rotary shaft seal, for shielding the second rolling-element bearing 48 in relation to the medium to be conveyed, is again disposed axially between the second rolling-element bearing 48, again configured as a ball bearing, for example, and the conveying gear wheel 24.

Lateral evasive movements of the conveying gear wheel 24 are substantially completely precluded also in this configuration embodiment, so that excessive wear on the conveying gear wheel 24, in particular in the region of the radially outer teeth of the latter, can be precluded.

By virtue of the avoidance of non-lubricated contact between a conveying gear wheel supported on a drive shaft and a wall surrounding a conveying chamber, the operating life span of a gear pump of this type can be substantially increased with the gear pump constructed according to the disclosure, in particular when the gear pump is used, for example, in a fuel-operated vehicle heating apparatus in conjunction with non-lubricating or only poorly lubricating fuels, for conveying the latter into a combustion chamber, without comparatively complex structural measures being required to this end, or the introduction of a radial intermediate space between the teeth of a conveying gear wheel and a wall of a pump housing that surrounds the conveying chamber being required, the intermediate space leading to the conveying efficiency being compromised.

It is understood that the foregoing description is that of the preferred embodiments of the invention and that various changes and modifications may be made thereto without departing from the spirit and scope of the invention as defined in the appended claims.

1. A gear pump comprising:
a pump housing defining a conveying chamber;
a housing cover closing said conveying chamber at least in regions thereof;
a conveying gear wheel defining a rotation axis and being rotatable about said rotation axis in said conveying chamber;
a drive shaft coupled to said conveying gear wheel for co-rotation therewith about said rotation axis;
said conveying gear wheel having first and second axial sides;
a first bearing unit for mounting said drive shaft on said first axial side of said conveying gear wheel; and,
a second bearing unit for mounting said drive shaft on said second axial side of said conveying gear wheel.

2. The gear pump of claim 1, wherein at least one of the following applies:
i) said drive shaft is mounted relative to the pump housing via said first bearing unit; and,
ii) said drive shaft is mounted relative to said housing cover via said second bearing unit.

3. The gear pump of claim 1, wherein said drive shaft is self-supporting between said first bearing unit and said second bearing unit.

4. The gear pump of claim 1, wherein said first bearing unit is at a first axial spacing from said conveying gear wheel and said second bearing unit is at a second axial spacing from said conveying gear wheel; and, said second axial spacing is less than said first axial spacing.

5. The gear pump of claim 2, wherein said first bearing unit includes a first rolling-element bearing.

6. The gear pump of claim 5, wherein said first rolling-element bearing includes a ball bearing.

7. The gear pump of claim 5, wherein said first bearing unit includes a first shaft seal disposed axially between said first rolling-element bearing and said conveying gear wheel; and, said first shaft seal is configured to provide a fluid-tight connection between said drive shaft and said pump housing.

8. The gear pump of claim 1, wherein said second bearing unit includes a second rolling-element bearing.

9. The gear pump of claim 8, wherein said second rolling-element bearing includes a ball bearing.

10. The gear pump of claim 7, wherein said second bearing unit includes a second shaft seal axially between said second rolling-element bearing and said conveying gear wheel; and, said second shaft seal is configured to provide a fluid-tight connection between said drive shaft and said housing cover.

11. The gear pump of claim 1, wherein said second bearing unit includes a plain bearing bushing.

12. The gear pump of claim 11, wherein said plain bearing bushing is made using polymer material or composite material.

13. The gear pump of claim 1, wherein said gear pump is configured for conveying liquid fuel in a fuel-operated heating apparatus.

14. A fuel-operated vehicle heating apparatus comprising:
a burner region;
a fan configured to supply combustion air to said burner region;
a gear pump communicating with said burner region to supply liquid fuel thereto; and, said gear pump including:
a pump housing defining a conveying chamber;
a housing cover closing said conveying chamber at least in a region thereof;
a conveying gear wheel defining a rotation axis and being rotatable about said rotation axis in said conveying chamber;
a drive shaft coupled to said conveying gear wheel for co-rotation therewith about said rotation axis;
said conveying gear wheel having first and second axial sides;
a first bearing unit for mounting said drive shaft on said first axial side of said conveying gear wheel; and,
a second bearing unit for mounting said drive shaft on said second axial side of said conveying gear wheel.

15. The gear pump of claim 14, wherein at least one of the following applies:
i) said drive shaft is mounted relative to the pump housing via said first bearing unit; and,
ii) said drive shaft is mounted relative to said housing cover via said second bearing unit.

16. The gear pump of claim 14, wherein said drive shaft is self-supporting between said first bearing unit and said second bearing unit.

17. The gear pump of claim 14, wherein said first bearing unit is at a first axial spacing from said conveying gear wheel and said second bearing unit is at a second axial spacing from said conveying gear wheel; and, said second axial spacing is less than said first axial spacing.

18. The gear pump of claim 15, wherein said first bearing unit includes a first rolling-element bearing.

19. The gear pump of claim 18, wherein said first rolling-element bearing includes a ball bearing.

20. The gear pump of claim 18, wherein said first bearing unit includes a first shaft seal disposed axially between said first rolling-element bearing and said conveying gear wheel; and, said first shaft seal is configured to provide a fluid-tight connection between said drive shaft and said pump housing.
